(19) United States
(12) Patent Application Publication
(10) Pub. No.: US 2012/0128577 A1
(43) Pub. Date: May 24, 2012

(54) Metal oxide synthesis

(75) Inventor: Douglas Ellsworth, North Vancover (CA)

(73) Assignee: Blue Juice, Inc., San Rafael, CA (US)

(21) Appl. No.: 13/200,988

(22) Filed: Oct. 5, 2011

Related U.S. Application Data
(60) Provisional application No. 61/404,608, filed on Oct. 6, 2010.

(51) Int. Cl. C01D 15/02; B82Y 40/00

(52) U.S. Cl. 423/598; 977/896

(57) ABSTRACT

The present invention is generally directed to the synthesis of metal oxides. It is more specifically directed to the synthesis of metal oxides possessing useful electrochemical properties. In one method aspect, the present invention provides a method of making metal oxides that includes the following steps: a) feeding a mixture of at least two different compounds into a heating chamber, wherein the chamber temperature ranges between 500° C. and 1250° C., resulting in the production of at least one metal oxide; b) segmenting the metal oxide according to particle size ranges; c) selecting one or more particle size ranges and subjecting the selected ranges to a spray mechanism.

This patent application claims priority to U.S. Provisional Patent Application No. 61/404,608 filed Oct. 6, 2011, which is incorporated-by-reference into this document for all purposes.

### FIELD OF THE INVENTION

The present invention is generally directed to the synthesis of metal oxides. It is more specifically directed to the synthesis of metal oxides possessing useful electrochemical properties.

### BACKGROUND OF THE INVENTION

There are many reports regarding the synthesis of metal oxides. For instance, U.S. Pat. No. 6,645,673 (“'673 patent”) discusses a process for producing lithium titanate. The '673 patent states that the process includes the following steps: A mixture of titanium dioxide and at least one lithium compound selected from the group consisting of lithium carbonate, lithium hydroxide, lithium nitrate, and lithium oxide is presintered at a temperature between 670° C. or more and less than 800° C. to prepare a compound consisting of TiO₂ and Li₂TiO₃ or a compound consisting of TiO₂, Li₂TiO₃ and Li₄Ti₅O₁₂. The compound is then sintered at a temperature in the range of 800 to 950° C.

U.S. Pat. No. 7,541,016 (“'016 patent”) discusses a method of forming lithium titanate. The '016 patent states that the process includes the following steps: The lithium titanate is formed by providing a mixture of titanium dioxide and a lithium-based component. The mixture is sintered in a gaseous atmosphere comprising a reducing agent to form the lithium titanate having the formula Li₄Ti₅O₁₂.

U.S. Pat. No. 7,368,097 (“'097 patent”) discusses a process for preparing nanocrystalline lithium titanate spinels. The '097 patent states that the process includes the following steps: Lithium hydroxide and titanium alkoxide are reacted at an elevated temperature in a reaction mixture which forms water of reaction.

U.S. Pat. No. 7,211,350 (“'350 patent”) discusses the synthesis of nanostructured lithium titanate. The '350 patent states that the synthetic method includes the following steps: Li₄Ti₅O₁₂ is synthesized in a short duration process of annealing mixed TiO₂ and Li-source precursor compounds at about 800° C. for a time of about 15-30 minutes, which is not substantially longer than that required to effect maximum available reaction between the precursors.

International Patent Application WO 2010/087649 (“'649 application) discusses a method for producing lithium titanate with a nanostructure. The '649 application states that the method includes the following steps: A first step of providing lithium titanate with a nanotube structure and providing TiO₂ powder at a metastable state; a second step of enabling the TiO₂ powder to react in a LiOH aqueous solution to form stratified titanate containing the Li ingredient by an ion exchange method; a third step of heat treating the titanate to convert the stratified titanate into a nanotube structure; and a fourth step of drying the resulting material.

Chinese Patent Application CN 101659443 (“'443 application”) discusses a preparation method of spherical lithium titanate. The '443 application states that the method includes the following steps: Controlling the grain size of the precursor, the oil-water ration of an O/W system, the variety of emulsifiers, the selection of dose, secondary sintering temperature and other factors.

Chinese Patent Application CN 101659442 (“'442 application) discusses the preparation of spinel structure lithium titanate. The '442 application states that the preparation method includes the following steps: Performing high temperature calcination and then performing low-temperature heat preservation on the material containing the lithium source and the titanium source. The material containing the lithium source and the titanium source performs sintering reaction under a high-temperature condition, and the temperature of the material is maintained under a low-temperature condition to promote the crystal lattice perfection and the even particle size distribution of the lithium titanate.

Chinese Patent Application CN 101630732 (“'732 application”) discusses the preparation method for nanoscale lithium titanate. The '732 application states the preparation method includes the following steps: A lithium compound, a titanium compound and a doped element compound are mixed according to the molar ratio of 0.75-0.80:1:0:0.05 of Li to Ti to doped elements so as to form a mixture A; the mixture A and a complexing agent are mixed according to a weight ration of 1:0.1-10 and dissolved in water to form mixture B; and the mixture B and a carbon nanotube dispersion C are mixed to form the nanoscale lithium titanate compound coated by carbon nanotubes with a nanoscale grain size.

Despite the various reports regarding the synthesis of metal oxides, there is still a need for new methods of making metal oxides that provide compounds possessing useful electrochemical properties.

### BRIEF DESCRIPTION OF THE FIGURES

FIG. 1 shows a general representation of a pyrohydrolyzing apparatus.

### SUMMARY OF THE INVENTION

The present invention is generally directed to the synthesis of metal oxides. It is more specifically directed to the synthesis of metal oxides possessing useful electrochemical properties.

In one method aspect, the present invention provides a method of making metal oxides that includes the following steps: a) feeding a mixture of at least two different compounds into a heating chamber, wherein the chamber temperature ranges between 500° C. and 1250° C., resulting in the production of at least one metal oxide; b) segmenting the metal oxide according to particle size ranges; c) selecting one or more particle size ranges and subjecting the selected ranges to a spray mechanism. The particles emerging from the spray mechanism have the following properties: i) they are roughly spherical aggregates of primary particles having a size ranging from 5.0μ to 20.0μ; ii) they have a tap density greater than 0.7 g/cc; iii) they have a surface area ranging from 5 m²/g to 50 m²/g; and, iv) they include less than 2.5% starting material.

### DETAILED DESCRIPTION OF THE INVENTION

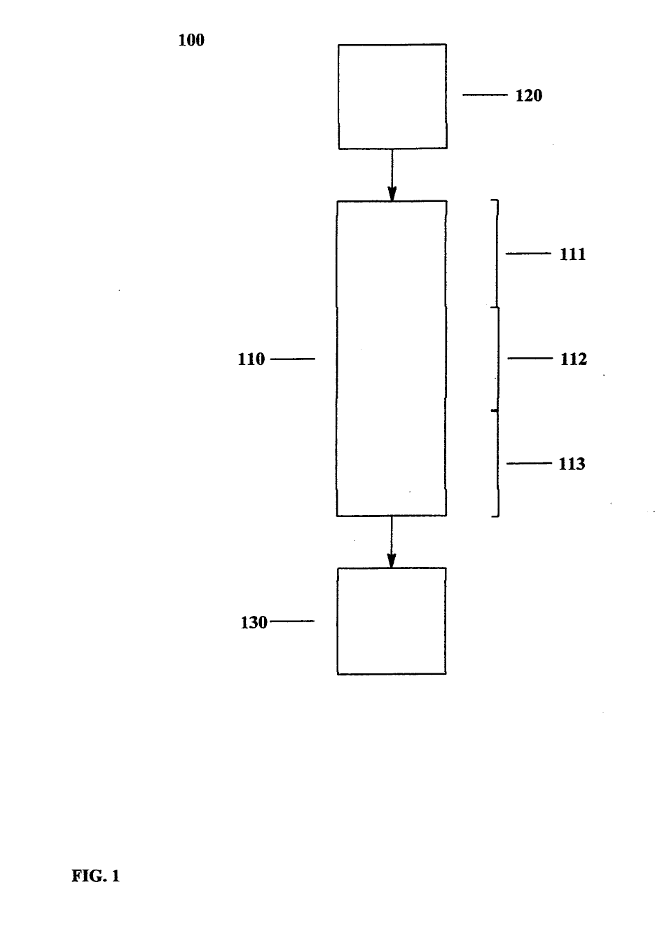

The present invention is directed to the synthesis of metal oxides. The disclosed synthetic method typically involves the use of a pyrohydrolyzing or similar apparatus. A general representation of such an apparatus (100) is shown in FIG. 1.

Referring to FIG. 1, feed solution is introduced into a heated chamber 110 (e.g., furnace tube) using feed mechanism 120. Feed mechanism 120 may be of any suitable type. Nonlimiting examples of feed mechanism types include gravity feed and pump feed (e.g., progressive cavity, peristaltic or membrane).

The feed solution typically includes at least two different compounds. For instance, in one case, the feed solution includes at least one lithium-based compound and one titanium-based compound. Nonlimiting examples of lithium compounds that may be included in the feed solution are: lithium carbonate, lithium hydroxide, lithium nitrate, lithium oxide, and lithium chloride. Nonlimiting examples of titanium compounds that may be included in the feed solution are: titanium dioxide, titanium hydroxide, titanium tetrachloride, and various titanium alkoxides (e.g., titanium tetramethoxide, titanium tetraethoxide, and titanium tetraisopropoxide).

The solvent for the feed solution may be aqueous, organic based or mixtures of aqueous and organic based (where these are miscible) Non-limiting examples of aqueous based solutions are water. Non-limiting examples of organic based solutions are ethanol, methanol, and propylene glycol. The feed solution may optionally contain other additives. Non-limiting examples of such additives are Polyethyleneimine (PEI) and Hydroxyfunctional carboxylic ester.

The concentration of the two different compounds in the feed solution may be of any suitable amount. For example, where a first compound in the feed solution is TiO₂, and the second compound is LiOH.H₂O, the TiO₂ is typically included in a concentration ranging from 5% to 25% (weight %), and the LiOH.H₂O is typically included in a concentration ranging from 5% to 10% (weight %). In certain cases, the TiO₂ concentration ranges from 10% to 25%, 15% to 25%, 17.5% to 22%, 19% to 21%, or about 20%. Oftentimes, the LiOH.H₂O concentration ranges from 5% to 9.5%, 6% to 9%, or 7% to 8.5%, or about 8%. Othertimes, the Li₂(CO₃) concentration ranges from 5% to 9.5%, 6% to 9%, 7% to 8.5%, or about 8%. At othertimes, the Li(NO₃) concentration ranges from 5% to 9%, 6% to 8.5%, 7% to 8%, or about 7.5%.

The atmosphere of the heated chamber to which the feed solution is added is typically controlled. For instance, in certain cases the partial pressure of oxygen in the chamber is controlled to be between 21 kPa and 0.1 Pa. Oftentimes the partial pressure is controlled to be between 10 kPa and 0.1 Pa, 5 kPa and 0.1 Pa, 1 kPa and 0.1 Pa, 100 Pa and 0.1 Pa, 10 Pa and 0.1 Pa, or 1 Pa and 0.1 Pa.

The temperature of the heated chamber typically ranges between 250° C. and 1250° C. Oftentimes, the temperature within 111 ranges between 350° C. and 1100° C., 400° C. and 1100° C., 400° C. and 1000° C., 450° C. and 950° C., or 500° C. and 900° C. The temperature within 112 typically ranges between 250° C. and 1250° C. Oftentimes, the temperature within 112 ranges between 500° C. and 1150° C., 600° C. and 1100° C., 700° C. and 1050° C., or 800° C. and 1000° C. The temperature within 113 typically ranges between 250° C. and 1250° C. Oftentimes, the temperature within 113 ranges between 400° C. and 1100° C., 450° C. and 1000° C., 500° C. and 950° C., or 600° C. and 900° C.

Reacted product emerges from heated chamber 110 and enters a collection unit 130 (e.g., cyclone, classifier). Collection unit 130 provides for particle size segmentation of the metal oxide. Particle size in 130 of the collection unit is typically in the range of 0.5 μm-100 μm. Oftentimes the particle size range in 130 is 2 μm-50 μm or 5 μm-20 μm.

Metal oxide particles of a particular size range emerge from collection unit 130 and are rapidly cooled, typically by either air or inert gas.

The dried metal oxide particles are typically aggregates of smaller particles (i.e., primary particles). The particles are typically, roughly spherical and oftentimes include an internal space that does not include metal oxide (i.e., hollow portion). Particle size typically ranges from 0.5μ to 50μ. Oftentimes the particle size ranges from 1.0μ to 40μ, 2.0μ to 30μ, 3.0μ to 25μ, 4.0μ to 22.5μ or 5.0μ to 20.0μ. Primary particle size typically ranges from 10 nm to 250 nm. Oftentimes, the primary particle size ranges from 20 nm to 200 nm, 20 nm to 150 nm, 40 nm to 125 nm, or 50 nm to 100 nm.

Particles typically have a tap density greater than 0.5 g/cc. Oftentimes, the tap density of the particles is greater than 0.55 g/cc, 0.60 g/cc, 0.65 g/cc, or 0.70 g/cc. The surface area of the particles typically ranges from 5 m²/g to 50 m²/g. Oftentimes, particle surface area ranges from 7.5 m²/g to 40 m²/g, 10 m²/g to 30 m²/g, 12.5 m²/g to 25 m²/g, or 15 m²/g to 20 m²/g. The particles are typically of high purity, with less than 10% unreacted starting material (e.g., TiO₂) being included in the metal oxide particles. In certain cases, less than 7.5%, 5.0%, 2.5%, 1.0% or 0.5% of starting material is included in the metal oxide particles.

Particles typically are mostly of spinel crystal structure. Oftentimes, the particles are greater than 75%, 80%, 85%, or 90% spinel. In certain cases, the particles are greater than 91%, 92%, 93%, 94% or 95% spinel. In other cases, the particles are greater than 95.5%, 96.0%, 96.5%, 97.0%, 97.5%, 98.0% or 98.5% spinel.

1. A method of making metal oxides, wherein the method consists essentially of the following steps:
a) feeding a mixture of at least two different compounds into a heating chamber, wherein the chamber temperature ranges between 500° C. and 1250° C., resulting in the production of at least one metal oxide;
b) segmenting the metal oxide according to particle size ranges;
c) selecting one or more particle size ranges and subjecting the selected ranges to a spray mechanism
wherein the particles emerging from the spray mechanism:
i) are roughly spherical aggregates of primary particles having a size ranging from 5.0μ to 20.0μ;
ii) have a tap density greater than 0.7 g/cc;
iii) have a surface area ranging from 5 m²/g to 50 m²/g; and,
iv) include less than 2.5% starting material.

2. The method according to claim 1, wherein the heating chamber has a first zone, a second zone, and a third zone, and wherein the temperature in the first zone ranges between 350° C. and 1100° C., and wherein the temperature in the second zone ranges between 500° C. and 1150° C., and wherein the temperature in the third zone ranges between 400° C. and 1100° C.

3. The method according to claim 1, wherein the primary particle size ranges from 10 nm to 250 nm.

4. The method according to claim 1, wherein the particles emerging from the spray mechanism have a surface area ranging from 12.5 m²/g to 25 m²/g.

5. The method according to claim 1, wherein the particles emerging from the spray mechanism include less than 1.0% starting material.

6. The method according to claim 1, wherein a first of two different compounds is selected from the group consisting of lithium carbonate, lithium hydroxide, lithium nitrate, lithium oxide and lithium chloride and a second of two different compounds is selected from a group consisting of titanium dioxide, titanium hydroxide, titanium tetrachloride, titanium tetramethoxide, titanium tetraethoxide and titanium tetraisopropoxide.

7. The method according to claim 1, wherein the mixture of at least two different compounds is fed into the heating chamber as a solution, and wherein the solution is either aqueous based or organic based, and wherein organic based solutions comprise an organic solvent, and wherein the organic solvent is selected from a group of organic solvents consisting of ethanol, methanol and propylene glycol.

8. The method according to claim 1, wherein the heated chamber has a controlled atmosphere, and wherein the partial pressure of oxygen in the controlled atmosphere is between 21 kPa and 0.1 Pa.

9. The method according to claim 1, wherein the particles emerging from the spray mechanism have a crystal structure that is greater than 95.0% spinel.

10. The method according to claim 1, wherein the particles emerging from the spray mechanism include an internal space that does not include metal oxide.

11. The method according to claim 6, wherein the first of two different compounds is fed into the heated chamber in a concentration ranging from 5 weight percent to 25 weight percent and the second of two different compounds is fed into the heated chamber in a concentration ranging from 5 weight percent to 10 weight percent.

12. The method according to claim 7, wherein the solution further comprises an additive, and wherein the additive is selected from a group consisting of polyethyleneimine and hydroxyfunctional carboxylic acid ester.
